(19) United States
(12) Patent Application Publication
(10) Pub. No.: US 2011/0091053 A1
(43) Pub. Date: Apr. 21, 2011

(54) VIBRATORY PLATE, ELECTRO-ACOUSTIC CONVERTER, MANUFACTURING METHOD OF VIBRATORY PLATE AND MOLDED BODY

(75) Inventors: Takayuki Iseki, Kanagawa-ken (JP); Takumu Tada, Kanagawa-ken (JP); Yuichiro Minakuchi, Kanagawa-ken (JP)

(73) Assignee: VICTOR COMPANY OF JAPAN, LIMITED, Yokohama-shi, Kanagawa (JP)

(21) Appl. No.: 12/995,963

(22) PCT Filed: Jun. 1, 2009
(86) PCT No.: PCT/JP2009/060007

§ 371 Date: Dec. 2, 2010

(30) Foreign Application Priority Data
Jun. 3, 2008 (JP) 2008-146144

(51) Int. Cl. H04R 1/00; B32B 3/10

(52) U.S. Cl. 381/191; 428/138; 156/243

(57) ABSTRACT

A vibratory plate includes a first layer (3) containing a fiber material and having a first surface and a second surface opposing the first surface, a second layer (2) containing a sliced natural wood in the form of a single sheet having a thickness less than 140 μm, the second layer having a third surface arranged on the second surface and a fourth surface opposing the third surface, and a resin part (4) provided in the first layer (3) and the second layer (2) to join the first layer (3) and the second layer (2) adhesively. The resin part (4) is arranged in the second layer (3) so that a fill ration of the resin part on the fourth surface gets smaller than a fill ration of the resin part on the third surface.

### TECHNICAL FIELD

The present invention relates to a vibratory plate, an electro-acoustic converter, manufacturing method of the vibratory plate and a molded body.

### BACKGROUND OF ART

Products made with natural woods have various uses, such as household furniture and interior illuminations. Recently, natural woods are also used for casings for home electric appliances and material for speakers. As interior circumstances directed to natural environment provides a space with calm and comfort, the importance of wooden products has become more common.

It is known that the physical property of a wood depends on its direction (i.e. anisotropic nature). For instance, in the application of wood for a vibratory plate, a standing wave becomes difficult to occur in comparison with vibratory plates made of paper or resin since the propagation velocity of sound in the fiber direction of wood differs from that in the other directions. Also, the wood has superior characteristics of high sonic speed, great rigidity and Young's modulus in comparison with paper or resin and great internal loss and small density (light weight) in comparison with metals etc. As the adoption of wood for audio equipments would allow an acquisition of both natural sound inherent in the wood and effect of appearance accompanied with improved visual quality, the use of wood as materials for vibratory plates etc. has received attention in recent years.

As an example of a vibratory plate utilizing wood, there is disclosed a technique of processing the vibratory plate by a thin sliced veneer (refer to e.g. Patent Documents 1 and 2). To prevent an occurrence of cracks on a curved surface of the sliced veneer, the Patent Documents 1 and 2 consist in impregnating a sheet, which consists of a paper and a wood glued together, with lubricant agent in order to soften the wood, thereby preventing the occurrence of cracks when press-forming the sheet.

More specifically, wood softened with softening agent (e.g. Japanese sake or the like) is shaped with pressure and subsequently subjected to temporary forming while evaporating moisture from the wood. To stabilize the shape of wood furthermore, it is carried out to impregnate the wood with thermo-setting resin and thereafter, high-temperature press forming is performed several times.

### PRIOR ART DOCUMENTS

### Patent Documents

Patent Document 1: Japanese Patent Publication Laid-open No. 2003-158798
Patent Document 2: Japanese Patent Publication Laid-open No. 2004-254013

### SUMMARY OF THE INVENTION

### Problems to be Resolved by the Invention

In the technique of performing impregnation or high-temperature press forming on the wood several times, however, there is a case of improving the productivity with difficulty because of its production requiring time and cost. In addition, as the softening agent may have a limit in its softening action, there is the possibility of producing a crack in wood when processing a body of shape with great curvatures. For instance, in case of utilizing wood for a relatively-small and thin vibratory plate, such as earphone and headphone, it is necessary to make the vibratory plate thinner and process it to a shape with a large curvature or a complicated shape. In this view, it has been desired to study the processing technique furthermore.

To reduce the thickness of a vibratory plate thereby allowing it to be processed to a shape with a large curvature or a complicated shape, it is contemplated to reduce the thickness of a wooden sheet. However, in case of adopting the method disclosed in Patent Documents 1 and 2 as a processing technique for a vibratory plate using such a thinned wooden, thermo-setting resin impregnated in the wooden sheet may exude on the side of a molding die at press forming, causing an adhesion to the molding die. As a result, the productivity may be reduced.

In addition, if the wooden sheet is impregnated with thermo-setting resin sufficiently, then the weight ratio of resin to the whole vibratory plate gets increased since the wooden sheet is covered, on its surfaces and overall inside, with resin. Consequently, when a wooden sheet impregnated with resin is utilized for the vibratory plate, there is the possibility that the characteristics of resin comes into existence greatly, so that advantageous properties inherent in the wood (acoustic characteristics) is provided with difficulty.

### Means of Solving the Problems

In consideration of the above-mentioned problems, an object of the present invention is to provide a vibratory plate, an electro-acoustic converter, a manufacturing method thereof and a molded body, which enable the plate to be weight-saved and processed to a shape with great curvatures or a complicated shape with ease and which can present advantageous properties inherent in the wood more effectively.

In order to attain the above object, one aspect of the present invention resides in the provision of a vibratory plate comprising: a first layer containing a fiber material and having a first surface and a second surface opposing the first surface; a second layer containing a sliced natural wood in the form of a single sheet having a thickness less than 140 μm, the second layer having a third surface arranged on the second surface, a fourth surface opposing the third surface and a gap formed between wood fibers of the natural wood containing a through-hole penetrating from the third surface to the fourth surface; and a resin part provided in the first layer and the second layer to join the first layer and the second layer adhesively, wherein the resin part is arranged in the wood fibers and the gap of the second layer so that a fill ration of the resin part on the fourth surface gets smaller than a fill ration of the resin part on the third surface.

Another aspect of the present invention resides in the provision of a method of manufacturing a vibratory plate, comprising the steps of: impregnating a first layer with resin, the first layer containing a fiber material and having a first surface and a second surface opposing the first surface; drying the first layer impregnated in the preceding step; preparing a second layer containing a sliced natural wood in the form of a single sheet having a thickness less than 140 μm, the second layer having a third surface, a fourth surface opposing the third surface and a gap formed between wood fibers of the natural wood containing a through-hole penetrating from the third surface to the fourth surface, and further arranging the third surface of the second layer on the second surface of the first layer; supplying the first layer and the second layer with water thereby to soften them; adhesively joining the first layer and the second layer through the resin by hot-pressing the first layer and the second layer softened in the preceding step so that the second layer is filled with the resin in the first layer; and molding the first layer and the second layer adhesively joined in the preceding step into a vibratory-plate shape, wherein the adhesively joining step consists in filling the wood fibers and the gap of the second layer with the resin in the first layer so that a fill ration of the resin on the fourth surface of the second layer gets smaller than a fill ration of the resin on the third surface.

The other aspect of the present invention resides in the provision of a method of manufacturing a vibratory plate, comprising the steps of: impregnating a first layer with resin, the first layer containing a fiber material and having a first surface and a second surface opposing the first surface; drying the first layer impregnated in the preceding step; preparing a second layer containing a sliced natural wood in the form of a single sheet having a thickness less than 140 μm, the second layer having a third surface, a fourth surface opposing the third surface and a gap formed between wood fibers of the natural wood containing a through-hole penetrating from the third surface to the fourth surface, and a fourth layer containing a sliced natural wood in the form of a single sheet having a thickness less than 140 μm, the fourth layer having a fifth surface and a sixth surface opposing the fifth surface and a gap formed between wood fibers of the natural wood containing a through-hole penetrating from the fifth surface to the sixth surface, and further arranging the fifth surface of the fourth layer on the first surface of the first layer; supplying the second layer, the fourth layer, and the first layer with water thereby to soften them; on condition of overlapping the third surface of the second layer softened in the preceding step and the second surface of the first layer softened in the preceding step on each other and also overlapping the fifth surface of the fourth layer softened in the preceding step and the first surface of the first layer softened in the preceding step on each other, adhesively joining the first layer, the second layer and the fourth layer through the resin by hot-pressing the first layer, the second layer and the fourth layer softened in the preceding step so that the second layer and the fourth layer are filled with the resin in the first layer; and molding the first layer, the second layer and the fourth layer adhesively joined in the preceding step into a vibratory-plate shape, wherein the adhesively joining step consists in: filling the wood fibers and the gap of the second layer with the resin in the first layer so that a fill ration of the resin on the fourth surface of the second layer gets smaller than a fill ration of the resin on the third surface; and filling the wood fibers and the gap of the fourth layer with the resin in the first layer so that a fill ration of the resin on the sixth surface of the fourth layer gets smaller than a fill ration of the resin on the fifth surface.

The other aspect of the present invention resides in the provision of a molded body comprising: a first layer containing a fiber material and having a first surface and a second surface opposing the first surface; a second layer containing a sliced natural wood in the form of a single sheet having a thickness less than 140 μm, the second layer having a third surface arranged on the second surface, a fourth surface opposing the third surface and a gap formed between wood fibers of the natural wood containing a through-hole penetrating from the third surface to the fourth surface; and a resin part provided in the first layer and the second layer to join the first layer and the second layer adhesively, wherein the resin part is arranged in the wood fibers and the gap of the second layer so that a fill ration of the resin part on the fourth surface gets smaller than a fill ration of the resin part on the third surface.

### EFFECT OF THE INVENTION

According to the present invention, it is possible to provide a vibratory plate, an electro-acoustic converter, a manufacturing method thereof and a molded body, which enable the plate to be weight-saved and easily processed to a shape with great curvatures or a complicated shape with neither producing any crack in its wood part nor adhering to a molding die at forming and which can present advantageous properties inherent in the wood more effectively.

### BRIEF DESCRIPTION OF THE DRAWINGS

FIG. 1 is a perspective sectional view showing an example of a molded body in accordance with an embodiment of the present invention.

FIG. 2 is a perspective sectional view showing an example of a molded body in accordance with a first modification of the embodiment of the present invention.

FIG. 3 is a perspective sectional view showing an example of a molded body in accordance with a second modification of the embodiment of the present invention.

FIG. 4(a) is a plan view of a vibratory plate in accordance with an embodiment of the present invention; FIG. 4(b) is a sectional view of the vibratory plate of FIG. 4(a); and FIG. 4(c) is a schematic view showing the details of an area A in FIG. 4(c).

FIG. 5 is a diagram showing an example of measurements in propagation velocity and internal loss between the vibratory plate of the embodiment of the present invention and respective vibratory plates of first to third comparison examples.

FIG. 6(a) is a plan view of a vibratory plate in accordance with the modification of the embodiment of the present invention and FIG. 6(b) is a sectional view of the vibratory plate of FIG. 6(a).

FIGS. 7(a) to 7(i) are explanatory views showing a manufacturing method of the vibratory plate in accordance with the embodiment of the present invention.

FIG. 8 is a sectional view showing an example of a first electro-acoustic converter mounting the vibratory plate in accordance with the embodiment of the present invention.

FIG. 9 is a sectional view showing an example of a second electro-acoustic converter mounting the vibratory plate in accordance with the embodiment of the present invention.

FIG. 10 is a perspective view showing an example of a lighting equipment using the molded body in accordance with the embodiment of the present invention.

### EMBODIMENTS OF THE INVENTION

An embodiment of the present invention will be described below, with reference to drawings. In the following descriptions about the drawings, identical or similar elements are indicated with the same or similar reference numerals, respectively. The following embodiment is illustrative of a device and a method for embodying a technical idea of the present invention. Thus, the technical idea of the present invention is not intended to specify the structures of constituents, their arrangement, etc. as follows.

—Molded Body—

A molded body 1a in accordance with an embodiment of the present invention contains fiber materials and includes a base material layer (first layer) 3 having a first surface and a second surface opposing the first surface, a surface layer (second layer) 2 containing natural wood sliced into a sheet so as to have a thickness less than 140 μm and having a third surface on the second surface and a fourth surface opposing the third surface, and a resin part 4 provided in both the base material layer 3 and the surface layer 2 to join the base material layer 3 to the surface layer 2 adhesively.

For the surface layer 2, there is employed a material obtained by slicing a pure natural wood into a piece of sheet. Needle leaf trees or broad leaf trees are available as the natural wood. Especially, in case of considering acoustic characteristics (propagation velocity, internal loss) as materials for the vibratory plate, there are advantageously employed broad leaf trees, for example, beech, linden, oak, cherry, zelkova serrata, Japanese cherry, lauan, birch, maple, etc. Among these trees, the broad leaf trees, such as birch and linden, are particularly preferable as the material for the vibratory plate since their sonic speeds are larger than those of the other materials.

For needle leaf tree, there are employed pine, cedar and cypress advantageously. In view of effective utilization of wood resource and environment, it is more preferable to employ thinned woods, such as cedar. Otherwise, woods described in e.g. Japanese Patent Publication Laid-open No. 2004-254013 may be used for the vibratory plate.

The surface layer 2 can be produced by applying a cutter blade onto a log wood in rotation, namely, “Katsura stripping”. The surface layer 2 may be manufactured by slicing a cross-grain lumber or a straight-grain lumber.

In case of using the broad leaf tree for the surface layer 2, it is desirable to use a sap wood rather than using a heart wood. The sap wood has the characteristics of being splinterless at molding due to its fine texture and therefore, it is especially preferable for a vibratory plate requiring a certain level of strength (rigidity) and durability.

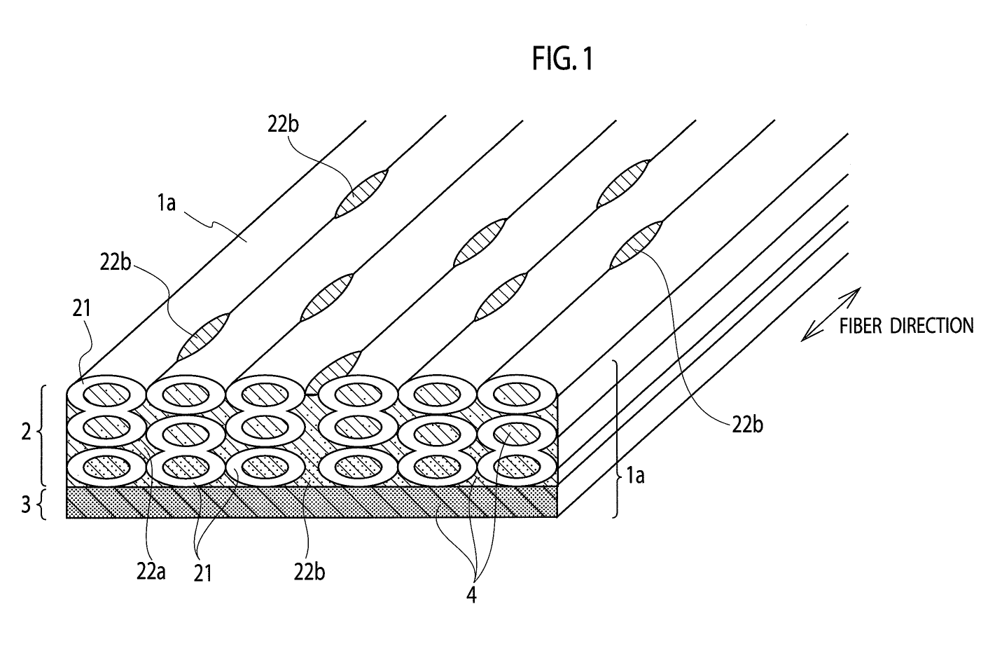

For the manufacturing of a molded body having a three-dimensional profile with great curvatures or a complicated three-dimensional profile, it is desirable to produce an ultrathin sheet with use of an ultra-smoothing wood planer. As the ultrathin sheet exhibits great light transmission properties, as described with FIG. 10 later, it is possible to apply the molded body 1a of FIG. 1 to a lighting equipment or the like. In addition, if such an ultrathin sheet is applied to a casing surface of mobile telephone, television or acoustical instrument, a frame surface of a speaker unit, a casket's surface or the like, then it is possible to attain weight-saving of an object to be applied therewith.

The surface layer 2 includes cellular tissues (wood fibers) 21 containing conduits or temporal conduits of a natural wood and gaps 22a formed in the cellular tissues 21 and therebetween, the gaps 22a being discontinuous in a cross-section direction of FIG. 1. If forming the surface layer 2a with a thickness less than a certain value, then the amount of the wood fibers 21 in the direction of thickness is reduced. Consequently, as shown in FIG. 1, minute gaps 22a between the wood fibers 21 appear in the form of a penetrating gap (through-hole) 22b extending from the surface (the fourth surface) to the back surface (the third surface), with the probability above a certain level. For instance, if making the thickness of the surface layer 2 less than 140 μm, which may change to a greater or lesser value due to the material of woods, then the surface layer 2 has not only improved light transmission properties but a flexible structure splinterless to great bending since many through-holes 22b are generated throughout the surface layer 2.

For instance, for the surface layer 2 of this embodiment, if a birch material is sliced so that a resultant sheet has a thickness less than approx. 80 μm, the length of the through-hole 22b appearing on the surface layer 2 becomes less than approx. 500 μm at the longest. In consideration of the rate of area of the through-holes 22 to the whole surface area of the surface layer 2, however, even if several through-holes 22 of 500 μm in length are formed on the surface layer 2, the profile of a sheet as the surface layer 2 of the embodiment could be maintained sufficiently since a surface layer's area consisting of the wood fibers 21 joined to each other is larger than the surface layer's area of the through-holes.

It is noted that the fiber density of a wood is not always constant because it is a product of nature. Therefore, for instance, if making the thickness of a birch material less than 50 μm, the wood fibers 21 gets scattered in some locations of the surface layer 2, so that the sheet configuration cannot be maintained. Although the most appropriate thicknesses for various wood materials are different from each other with respect to each material due to differences in largeness of their wood fibers 21, it is preferable that the thickness of the surface layer 2 generally ranges between 50 μm to 140 μm, more preferably, 80 μm to 120 μm.

Consequently, the surface layer 2 can be formed, between the wood fibers 2, with several through-holes 22b penetrating both surfaces of the surface layer 2 while maintaining the sheet configuration as the surface layer 2 (see FIG. 1). As the through-holes 22b bring the cushioning action when molding the molded body 1a and furthermore, the through-holes 22b and the gaps 22a are partially filled up with the resin part 4, the molded body 1a is reinforced without producing cracks, allowing the body 1a to be molded like a sheet or in three dimensions.

Fibrous materials, such as Japanese paper and nonwoven fabrics, are used for the base material layer 3 advantageously. For the nonwoven fabrics having high strengths, there are recommended “gampi (traditional Japanese paper made from the fiber of plant species of Diplomorpha sikokiana)”, Manila fiber, “kozo (paper mulberry)” and so on. As for the thickness of the base material layer 3, one has only to select a material or a thickness providing a strength required for the molded body 1a, appropriately. Even when manufacturing the molded bodies 1a having different thicknesses, one has only to change the thickness of the base material layer 3 only. Thus, as a natural wood sheet similar to the above-mentioned material is available for the surface layer 2, the custody control of natural wood sheets is simplified. In addition, by making the thickness of the base material layer 3, for example, between 10 μm and 15 μm, it is possible to attain the weight saving of the molded body and also possible to improve the light transmission property of an integrated body obtained by laminating the base material layer on the surface layer 2.

Thermo-setting resins, for example, resol-type phenolic resin, epoxy resin, urethane resin, etc. are used for the resin part 4 advantageously. The resin part 4 intrudes into fiber interiors (gaps) of the base material layer 3 in dispersion. In addition, the interiors of the wood fibers 21 of the surface layer 2 and both the gaps 22a and the through-holes 22b formed between the wood fibers 21 are filled up with the resin part 4. In this way, the base material layer 3 and the surface layer 2 are adhesively joined through the resin part 4 so as to form one body.

Although the detailed description will be given by the later-mentioned manufacturing method, the resin part 4 comprises resin layers which are obtained by firstly preparing the base material layer 3 impregnated with resin in advance and successively hot-pressing the layers 2, 3 so that the resin in the base material layer 3 gradually permeates the gaps 22a, 22b in the surface layer 2. Thus, in the definition of one surface of the surface layer 2 in contact with the base material layer 3 as a third surface and another surface of the layer 2 opposite to the third surface as a fourth surface, the fill ration of resin in the resin part 4 decreases gradually as advancing from the third surface of the surface layer 2 toward the fourth surface.

According to the cross-sectional observation of the molded body 1a of this embodiment, it is desirable that the fill ration of resin of the fourth surface of the surface layer 2 is less than 60%, more preferably, between approx. 10% and approx. 50%, supposing that the fill ration (ratio by weight) of resin of the third surface of the surface layer 2 is equal to 100%.

If the fill ration of resin of the fourth surface of the surface layer 2 is more than 60%, then the resin intruding into the gap 22b appears on the side of the fourth surface of the surface layer 2a, so that the whole fourth surface of the surface layer 2 might be covered with the resin part 4. As a result, there is the possibility that the resin part 4 on the whole fourth surface adheres to a molding die during the press working, so that processed goods are cracked or broken. Otherwise, there is the possibility that artificial brilliance comes into existence since the whole fourth surface is covered with the resin part 4, so that an appearance brought by using a natural wood as it is cannot be acquired.

Despite the fill ration of resin of the fourth surface of the surface layer 2 being more than 60% (e.g. approx. 70%), it is not impossible to mold the molded bodies 1a in small quantity. However, when the number of pressing operations increases with commercial production, cured resin becomes apt to adhere to a molding-die surface, so that resulting adhesives may exert an influence on the final profile of the molded body 1a. In addition, as the sticking of the molded body 1a to the mold surface tends to take place, there is a case that resulting merchandises are broken.

Hitherto, three-dimensional wood products having curved profiles have been manufactured by carving out pure woods. Further, in manufacturing “curved-surface” shaped wood products with small curvatures, such as cylindrical bodies, it has been attempted to reduce the processing cost and the usage of woods by a method of applying a thinly-sliced plate (sliced veneer) to a surface of a plastic casing, for example.

However, the method of carving out pure woods is nonproductive because its processing requires a lot of time and wood materials. In addition, as such a large consumption of wood materials causes a mass generation of machined woodchips, the same method is undesirable environmentally.

Furthermore, under the condition that the thickness of a wood material generally referred to as “sliced veneer” falls within the range of 150 μm to 500 μm, it is not preferable in view of process yield and processing accuracy to slice the wood material into pieces having a thickness less than 140 μm. On the other hand, if pressing a wood material having a thickness more than 140 μm into a shape with sharp curved surfaces or a complicated shape, then cracks are produced in the pressed wood material.

There is disclosed a method of preventing an occurrence of cracks at a curved-surface processing by laminating multiple composite sheets, each of which consists of a thinly-sliced wood sheet and a nonwoven fabric containing adhesive resin, on each other (Japanese Patent Publication Laid-open No. 5-83792). In this method, however, if the number of adhesive layers is increased, then the weight of a resulting lamination gets increased due to the weight of increased adhesive agent. In addition, as the laminating of multiple wood sheets induces a strength differential depending on the fiber direction of wood, cracks are easy to occur and it is difficult to mold a three-dimensional shape having a great curved-surface profile.

To the contrary, the molded body 1a of this embodiment includes the surface layer 2 consisting of a natural wool having a thickness less than 140 μm and the resin part 4 embedded in the gaps existing in the surface layer 2 and the base material layer 3 to make them adhere to each other integrally. Consequently, as the molded body is provided with a lightweight and high-strength structure in spite of its surface of natural wood, it is possible to process the molded body to a shape with great curvatures or a complicated shape with ease.

Further, as the resin part 4 permeating the surface layer 2 of the molded body 1 has a fill ration of resin reduced gradually as advancing from the third surface toward the fourth surface (That is, the fill ration of the resin part 4 on the fourth surface of the surface layer 2 is smaller than that of the resin part 4 on the third surface.), the permeation of the resin part 4 onto the whole fourth surface of the surface layer 2 is relatively small. Therefore, the baking of the resin part 4 onto the molding die at the press working is suppressed to improve the workability. In addition, since the occurrence of artificial brilliance on the surface layer 2 is suppressed, it is possible to provide the molded body with an appearance like a natural wood. When shaping the molded body 1a of FIG. 1 to a vibratory plate, it is possible to bring out favorable properties inherent in the wood more effectively, allowing a realization of high acoustic effects in comparison with paper or resin.

Again, the molded body 1a of this embodiment has a structure where the resin part 4 intertwines with the base material layer 3 and the surface layer 2 since the resin part 4 is dug from the base material layer 3 into the surface layer 2, so that they are joined to each other strongly. Therefore, comparing with the conventional composite sheet consisting of multiple layers adhering to each other through resin films, the molded body 1a is hard to exfoliate and tear owing to its strength increased by dipping of the resin part 4.

(1^{st}. Modification)

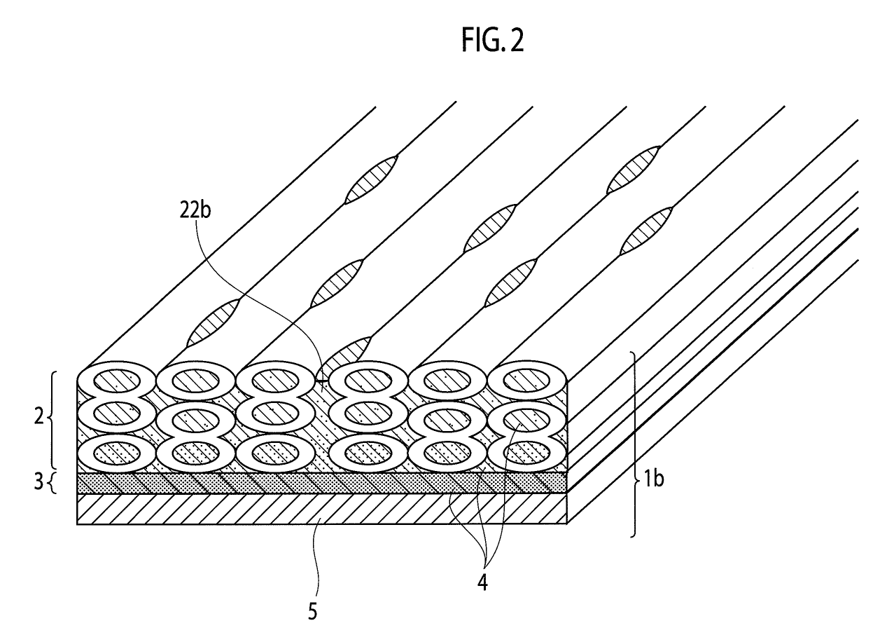

As shown in FIG. 2, a molded body 1b of the first modification differs from the molded body 1a of FIG. 1 in the provision of a reinforced layer (a third layer) 5 laminated on the backside (underside of FIG. 2: the first surface) of the base material layer 3. The reinforced layer 5 is bonded to the base material layer 3 through a thermo-setting resin layer or a thermoplastic resin layer (deleted in the figure).

There is no limitation as for the material of the reinforced layer 5. For instance, paper, cloth, plastic, metal plate, etc. are available as the material. In case of using as a vibratory plate, the thickness of the reinforced layer or its material has only to be determined in consideration of the weight of the vibratory plate. Preferably, a polymer film made of e.g. polypropylene, polyethylene terephthalate, etc. is used as the reinforced layer 5. As the surface layer 2 transmits light through the intermediary of resin component embedded in the gap 22 between the wood fibers 21, the transmission quantity of light gets increased in comparison with a thick sliced veneer having almost no gap 22b. In addition, owing to the interposition of the thin base material layer 3 between the surface layer 2 and the reinforced layer 5, it is possible to improve the adhesive strength furthermore. Also in FIG. 2, as the surface layer 2 is improved in strength by the permeating resin part 4 and also reinforced by the polymer film, it is contemplated to improve the strength of the resulting molded body furthermore.

(2^{nd}. Modification)

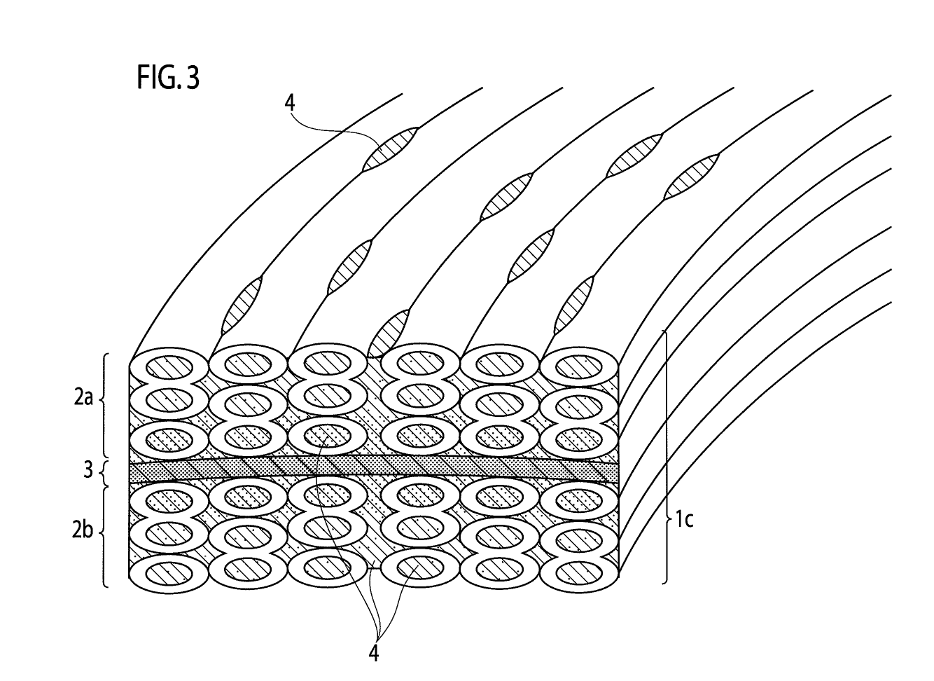

As shown in FIG. 3, a molded body 1c of the second modification includes a base material layer (first layer) 3 having a first surface and a second surface opposing the first surface, a surface layer (second layer) 2a laminated on the second surface of the base material layer 3, a back layer (fourth layer) 2b laminated on the first surface of the base material layer 3, and a resin part 4 provided in the base material layer 3, the surface layer 2a and the back layer 2b.

Material and constitution substantially similar to the surface layer 2 of FIG. 1 are available for the surface layer 2a and the back layer 2b. By arranging the back surface 2b, the molded body is covered, on both sides thereof, with woods. From the standpoint of appearance, therefore, the resulting molded body becomes similar to a molded body formed by only wood. In addition, by appropriately combining respective wood fiber directions of the surface layer 2a and the back layer 2b (For example, the surface layer 2a and the back layer 2b are laminated so that their fiber directions are perpendicular to each other.) or something, it is possible to prevent the molded body from being deformed with curvature. In case of using it as a speaker vibratory plate mentioned later, it is also possible to improve its acoustic characteristics due to appropriate control of anisotropic nature of the vibratory plate.

As the resin part 4 is embedded in the gaps of the surface layer 2a, the base material layer 3 and the back layer 2b by hot press, the molded body is improved in strength. As for the surface layer 2a and the back layer 2b, the usage of wood can be reduced by adopting a wood material having a thickness less than 140 μm.

By the hot press process, the molded body 1c of FIG. 3 enables resin to be deformed and hardened, so that its curved surface or three-dimensional shape can be maintained. In addition, even when bending the molded body 1c, there is no possibility of producing any major tear owing to the cushioning action by intermittent interfiber gaps formed in both the surface layer 2a and the back layer 2b. Again, as the resin part 4 embedded in the gaps penetrates respective insides of the surface layer 2a, the back layer 2b and the base material layer 3 deeply, the molded body 1c is reinforced by the resin part 4 almost entirely. Consequently, the resulting three-dimensional shape becomes stronger to provide the molded body 1c tough to deformation.

Owing to the woods on both sides of the molded body 1c, their beautiful grain on both sides exhibits the same body as if it were a thin natural wood while maintaining such a strong three-dimensional shape. For the demands of strengthening the three-dimensional shape of the molded body 1c further, it can be handled by increasing the content of resin in the resin part 4 or the thickness of the base material layer 3, so that there is no need of increasing the usage of wood. This means that the molded body is good for the environment.

—Vibratory Plate—

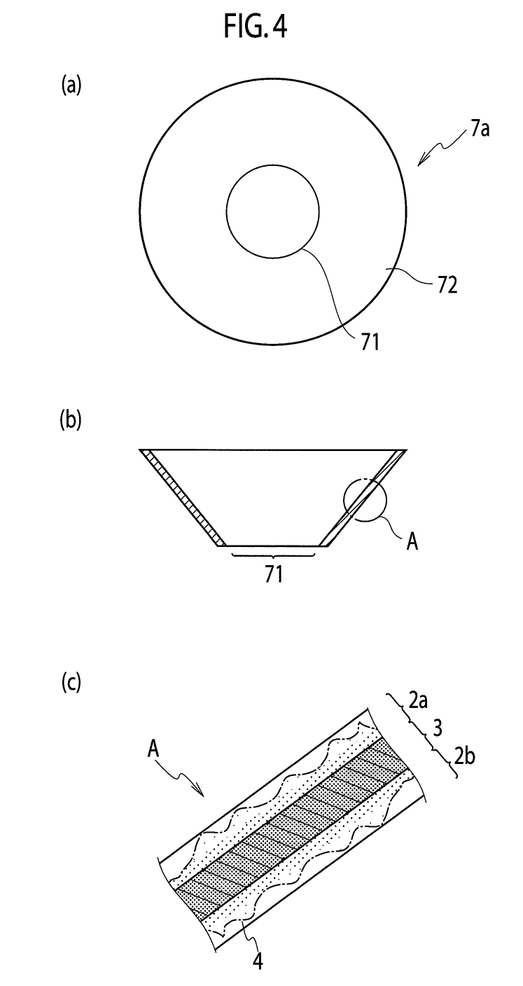

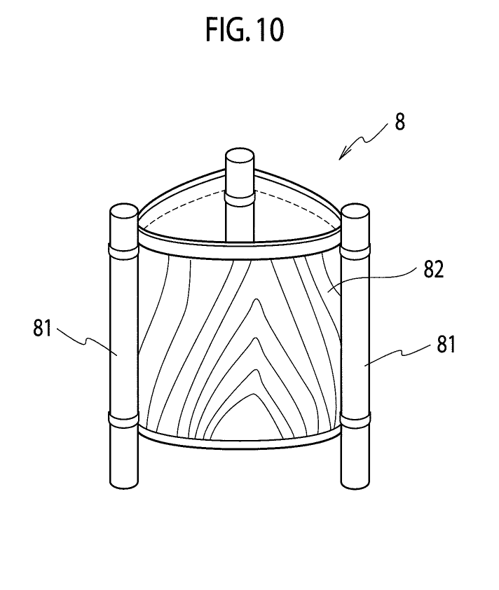

As shown in FIGS. 4(a) and 4(b), a vibratory plate 7a of this embodiment includes a conically-shaped vibrating part 72 and an opening part 71 at the substantial center of the vibrating part 72. The configuration of the vibrating part 72 is not limited to only the shape of FIGS. 4(a) and 4(b). For instance, it may be shaped so as to be a vibratory plate 16 of FIG. 9 having a doom-shaped cross section.

As shown in FIG. 4(c), the vibratory plate 7a comprises a surface layer 2a, a base material layer 3 and a back layer 3 laminated in this order. To form the surface layer 2a, the base material layer 3 and the back layer 3 into one body, a resin part 4 is embedded in these layers. Note that FIG. 4(c) illustrates an example of the vibratory plate 7a adopting the molded body 1c of FIG. 3. Of course, vibratory plates using the molded bodies 1a, 1b of FIGS. 1 and 2 are adoptable for the vibratory plate of the embodiment.

For appropriate characteristics of a speaker having the vibratory plate 7a, it is necessary to enlarge its piston moving region by enhancing the natural vibration frequency of the vibratory plate 7a. For this purpose, there is required the physical property of a vibratory-plate material having a high propagation velocity (sonic speed), that is, a high value of Young's modulus/density. Further, the regenerative frequency characteristic has to be more flattened by suppressing resonance peaks due to the natural vibration frequency. In this view, there is required the physical property of a vibratory-plate material having a large internal loss.

As utilized as musical instruments, wood is characterized by its high propagation velocity and large internal loss. The vibratory plate 7a of this embodiment has a high sonic speed and a large internal loss due to the usage of wood material on the surfaces. In addition, owing to the resin part 4 permeating the interior side of the surface layer 2a and the back layer 2b, the strength as the vibratory plate is enhanced with increased rigidity. Moreover, since the wool material having a thickness less than 140 μm is utilized, the vibratory plate 7a can be provided with reduced thickness and weight. Still further, with an enhanced degree of freedom in molding, it is also possible to adopt a vibratory-plate structure with reinforcing ribs.

FIG. 5 shows an example of measurements in propagation velocity and internal loss about the vibratory plate 7a of this embodiment and respective plates of the first comparison example (conventional wooden vibratory plate), the second comparison example (conventional paper vibratory plate) and the third comparison example (aluminum vibratory plate). As for materials forming the vibratory plate 7a of this embodiment, there are used birch for the surface layer 2a and the back layer 2b, “gampi paper” (traditional Japanese paper made from the fiber of plant species of Diplomorpha sikokiana) for the base material layer 3 and phenol resin for the resin part 4.

From FIG. 5, it is found that the vibratory plate 7a of this embodiment has a high propagation velocity in comparison with the first comparison example (made of wood) and the second comparison example (made of paper). In this regard, it is supposed that the elasticity moduli of the surface layer 2a and the back layer 2b are maintained highly in spite of the reinforcement of the base material layer 3 and that the effects of saving the weight and enhancing the strength due to the resin part 4 is added to improve the properties in comparison with the conventional vibratory plates. The internal loss of this embodiment is similar to that of the first comparison example (made of wood) and extremely larger than that of the third comparison example (made of aluminum). As material such as aluminum represents small internal loss despite its high propagation velocity, the same material is mainly used in high-frequency tweeters or the like. According to the embodiment of the present invention, meanwhile, as the vibratory plate 7a has a propagation velocity superior to the high-frequency characteristic and also an internal loss close to that of the conventional vibratory plate made of wood or paper, the vibratory plate 7a becomes an excellent vibratory plate coping with a wide frequency range.

(Modification)

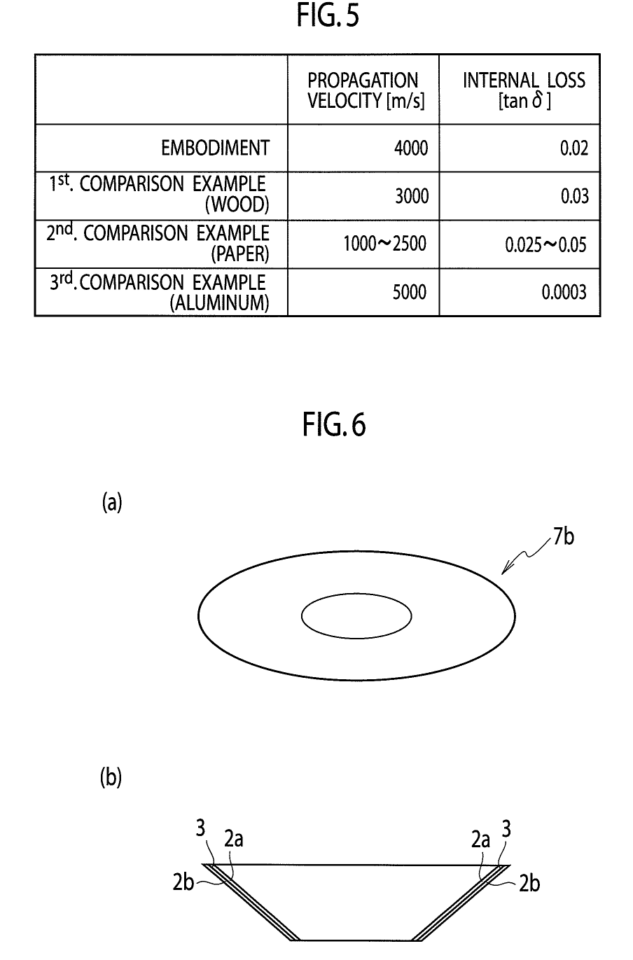

In this modification, as shown in FIGS. 6(a) and 6(b), the vibratory plate is shaped so as to be non-symmetrical about a point, for example, shape of an ellipse. If a vibratory plate 7b is shaped of an ellipse, its strength changes depending on its orientation. In detail, when the vibratory plate 7b is shaped of an ellipse, the plate's strength in its longitudinal direction (horizontal direction on paper) is so large that the deflection of the vibratory plate 7b is small. Therefore, if adopting an isotropic vibratory-plate material for the vibratory plate, a speaker part in the lateral direction at vibration becomes easy to be deflected.

On the contrary, wood has anisotropic characteristics depending on the fibrous direction, that is, the wood strength in the fibrous direction is larger than the strength in the nonfibrous direction. Accordingly, if making the longitudinal direction of an ellipse shape perpendicular to the fibrous direction of wood, then a strength differential caused by such a non-symmetrical shape can be cancelled by a strength differential by wood's anisotropic characteristics, allowing the vibratory-plate strength to be well-balanced despite its ellipse configuration. Accordingly, since the deflection of a vibratory plate vibrated as a speaker is reduced, the acoustic characteristics become favorable.

—Manufacturing Method of Vibratory Plate (Molded Body)—

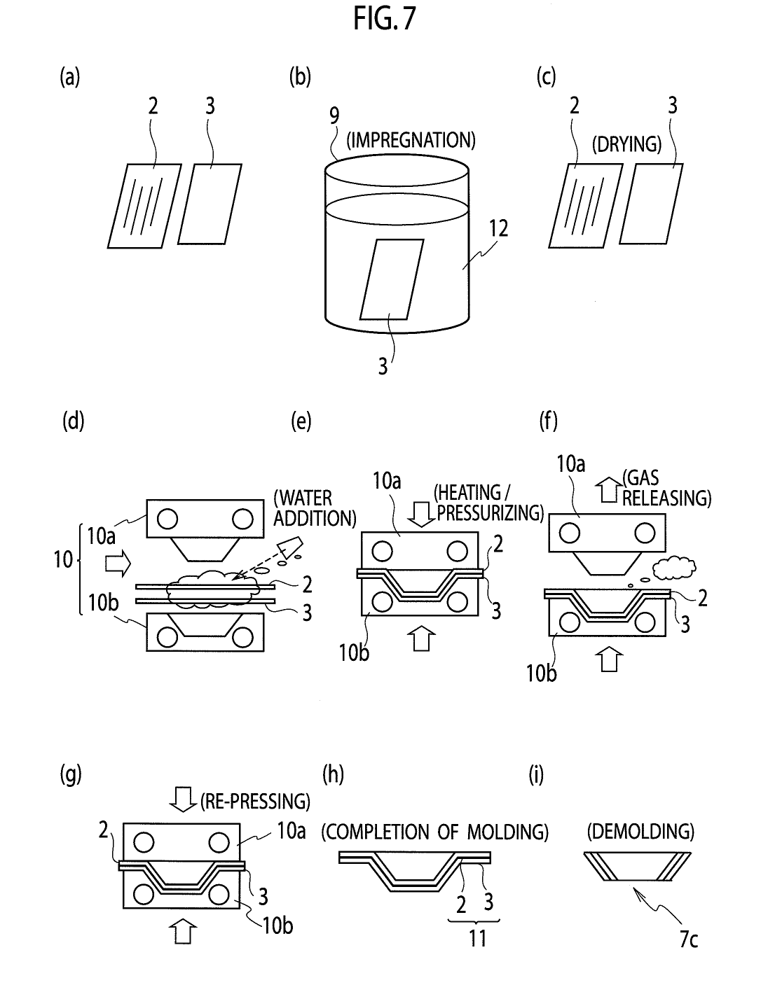

FIGS. 7(a) to 7(i) illustrate an example of a method of manufacturing a vibratory plate 7c of the embodiment of the present invention. Note that, as for the molded bodies 1b, 1b, 1c of FIGS. 1 to 3 and the vibratory plates 7b, 7c of FIGS. 4(a) to 4(c) and FIGS. 6(a) and 6(b), of course, there may be adopted manufacturing methods similar to that of FIGS. 7(a) to 7(c).

First, as shown in FIG. 7(a), the surface layer 2 and the back layer 3 are prepared in the form of sheets. Advantageously used as the surface layer 3 is one piece of sheet containing an interfiber gap penetrating through both sides of the sheet, which has been obtained by slicing a pure dicotyledonous wood (birch) of approx. 50 μm-120 μm in thickness into a sheet having a thickness less than 140 μm. Unwoven fabric etc. is used as the base material layer 3.

In the surface layer 2 and the base material layer 3 prepared in this way, as shown in FIG. 7(b), only the base material layer 3 is dipped in a container 9 accommodating resin solution 12 for a certain period (for example, from 10 minutes to 1 hour) to impregnate the inside of the base material layer 3 with resin sufficiently. If impregnating the surface layer 2, then the resin would adhere to the whole surfaces of the layer to increase its weight. At the time of press forming, in addition, the resin curing between the surface layer 2 and the molding die 10 might be stuck fast to preclude a separation of the die 10 from the surface layer 2. From this reason, it is preferable not to impregnate the surface layer 2 with resin.

For example, phenol resin as thermo-setting resin is available as the resin solution 12 of FIG. 7(b). When the quantity of resin is too much, the resin solution may be diluted by e.g. methanol solution. Although an optimum concentration of the resin changes depending on respective thicknesses of the base material layer 3 and the surface layer 2, it is generally preferable that the smaller the thickness of a material to be impregnated with resin gets, the lower the concentration of the resin becomes.

As shown in FIG. 7(c), the base material layer 3 is picked up from the container 9 and subsequently dried by hot air. Once the base material layer 3 is dried, the handling of the base material layer 3 is facilitated in comparison with a nondrying case, improving the operating efficiency in manufacturing. Besides, the base material layer 3 may be died naturally.

As shown in FIG. 7(d), the surface layer 2 is laminated on the base material layer 2 and successively, they are arranged in the press molding die 10 established at a predetermined temperature. The press molding die 10 comprises a male die 10a and a female die 10b. Then, it is desirable to apply a mold-releasing treatment on respective surfaces of the male die 10a and the female die 10b so that the surface layer 2, the resin solution 12 and the base material layer 3 affix themselves to the molding die 10 with difficulty. The mold-releasing treatment may be accomplished by, for example, applying mold-releasing agent or film, such as Teflon (trademark), on the surfaces of the molding die 10 and so on. This is because the resin exudes from a small gap (the gap 22b of FIG. 1) penetrating both sides of the surface layer 2 to the surface of the natural wood and consequently, the resin reaches the surfaces of the molding die 10 partially. The temperature of the molding die 10 is required enough for the resin to become hardened. For instance, a certain temperature between 160° and 220° is appropriate.

In succession, the base material layer 3 and the surface layer 2 are exposed in the water-vapor atmosphere to soften them. The expression of “exposing in the water-vapor atmosphere” means that, for example, it is executed to spray vapor or water against the base material layer 3, thereby spraying vapor against the molding die 10. Alternatively, the situation of “exposing in the water-vapor atmosphere” may be created by a method of allowing the base material layer 3 and the surface layer 2 to contain moisture. Considering the processing facility for a molded body with great curvatures, more moisture content in the base material layer 3 and the surface layer 2 would be more preferable since they could be inflated by the moisture.

As shown in FIG. 7(e), the base material layer 3 and the surface layer 2 are deformed by pressing them under a predetermined pressure.

When the surface layer 2 as a natural wood is bent as shown in FIG. 7(e), the gap part penetrating both surfaces of the surface layer 2 acts as a shock-absorbing region in addition to the softening of wood due to water vapor. Therefore, the surface layer becomes easy to be formed into a curved surface shape without producing any major tear in the wood part.

Preferably, the press conditions, for example, press temperature, time and pressure condition are adjusted alternately. For instance, when press temperature and time are fixed at 220° C. and 30 sec. respectively, it is preferable to establish a pressure between 0.2 MPa and 1.5 MPa. If the pressure is established more than 1.5 MPa under the above-mentioned condition, too much resin comes to exude over the surface layer 2 and affixes itself to the molding die 10. Consequently, there is the possibility that the molded body cannot be separated from the molding die 10, causing the molded body to be broken. According to inventors' investigation, it is also confirmed that if the pressure is established less than 0.2 MPa, then the resin cannot permeate the inside of the surface layer 2 sufficiently, so that the molded body becomes easy to be deformed after forming. Note that, when the processing temperature is established lower than 220° C., it is desirable to make an upper pressure limit smaller than 1.5 MPa and a lower pressure limit larger than 0.2 MPa so that the resin cannot exude over the entire surface of the surface layer 2.

As shown in FIG. 7(f), after a predetermined period has passed since the molded body was once pressed, the molding die 10 (the male die 10a and the female die 10b) is opened to release water vapor from the die. Consequently, moisture and solvent gas for the resin is released from the base material layer 3 and the surface layer 2. As a result, it is possible to suppress a residence of gas in the base material layer 3 and the surface layer 2. It is noted that an optimum value for the releasing period changes depending on a pressure value and a mold temperature. Specifically, for example, under the condition of 200° C. in temperature of the molding die 10 and 0.5 MPa in pressure, the moisture and the solvent component in the surface layer 2 and the base material layer 3 evaporate sufficiently by releasing the molding die for approx. 10 sec. just one time in succession to the pressing operation for approx. 10 sec.

As shown in FIG. 7(g), the pressing operation is carried out once again. This pressing operation is maintained at a predetermined pressure for a predetermined period until the resin becomes hardened while permeating the surface layer 2 gradually. For instance, at a steam temperature and a steam pressure, the resin becomes hardened for approx. 30 sec. The resin is expanded by the pressure of the pressing operation to permeate all over the surface layer 2 and the base material layer 3 furthermore. Then, it is desirable to control the behavior of resin so that it is embedded into part of interfiber gaps in the surface layer 2 while the resin impregnated in the base material layer 3 does not exude over the whole surface of the surface layer 2 (on the side of the fourth surface). Thus, by appropriately controlling temperature, pressure and time at the press forming so that resin in the base material layer can sink into the surface layer 2 gradually, it is possible to create a gradient where the fill ration of resin inside the surface layer 2 made of natural wood decreases gradually as advancing from the one layer's surface in contact with the base material layer 3 (i.e. the third surface) toward another layer's surface in noncontact with the base material layer 3 (i.e. the fourth surface). In addition, with such an appropriate control on temperature, pressure and time at the press forming, it is possible to control the fill ration of resin in the surface layer 2 in a fixed range while controlling an exuding of resin on the whole surface of the layer. As a result, as the quantity of resin adhering to the molding die 10 can be reduced, the workability is improved with the prevention of the adherence of resin.

As shown in FIG. 7(h), the molded body 11 is taken out from the molding die 10 and cooled down. Thereafter, as shown in FIG. 7(i), by cutting off a frame part and an opened part for a predetermined vibratory-plate shape, a vibratory plate 7c of this embodiment can be manufactured.

According to the method of manufacturing a vibratory plate of this embodiment, as the adhesive integration between the surface layer 2 and the base material layer 3 and their molding operation can be accomplished by hot press at the same time of softening the surface layer 2 with water vapor, the press process is simplified to raise the productivity. Throughout the press process shown in FIGS. 7(d) to 7(g), it is executed to embed impregnated resin of the base material layer 3 into the gap 22d penetrating both sides of the surface layer 2 while controlling the behavior of the resin part 4 so as not to exude over the whole surface of the surface layer 2 (on the side of the fourth surface). Consequently, as the resin part 4 does not adhere to the molding die at press working, the molded body can be processed without producing any crack or breakage and in addition, the efficient operation is implemented. Still further, as the whole surface of the surface layer 2 is not covered with resin in the completed vibratory plate, it is possible to allow the vibratory plate to present advantageous properties inherent in the wood more effectively.

The example shown in FIGS. 7(a) to 7(i) is illustrative of the method of manufacturing a vibratory plate by way of example. However, in case of manufacturing the molded body 1a of FIG. 1, for example, an iron in place of the molding die 10 may be used to adhesively join the surface layer 2 and the base material layer 3 in lamination through steam, heating and pressure of the iron.

In the example of FIGS. 7(a) to 7(i), thermo-setting resin is used as the resin. However, if e.g. thermoplastic resin is used as the resin, it would be desirable that a situation where the molded body is being pressed by a heated molding die is maintained for a given length of time and thereafter, the resulting molded body 11 is picked up from the die after it has been cooled down.

—Electro-Acoustic Converter—

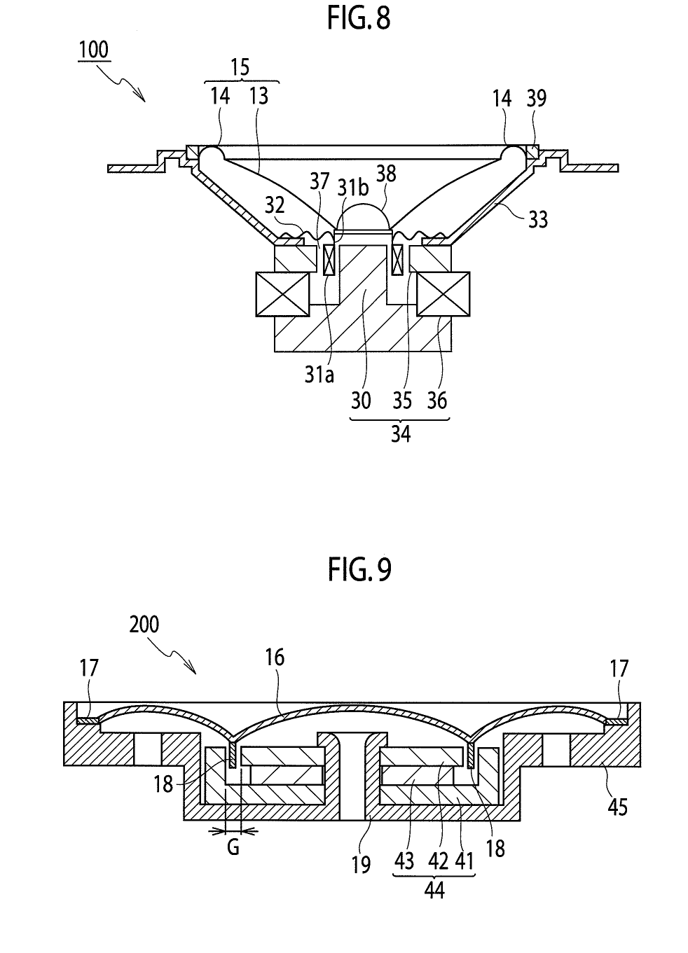

As shown in FIG. 8, a first electro-acoustic converter 100 includes a toroidal plate 35, a magnetic circuit 34 having a toroidal magnet 36 below the plate 35 and a pole piece 30, a frame 33 arranged on the magnetic circuit 34 and a vibratory plate 15 fixed to the frame 33. A voice coil 31a is loosely inserted into a magnetic gap 37 between the plate 35 and the pole piece 30. A damper 32 is joined to a voice-coil pin 31b and the frame 33 adhesively.

The molded bodies 1a to 1c of this embodiment may be used as the vibratory plate 15 of FIG. 8. The vibratory plate 15 includes a vibratory member 13 having a cone-shaped (conical) cross section and a rubber edge 14 attached to the whole circumference of a peripheral part (edge) of the vibratory member 13. The rubber edge 14 is fixed to the frame 33 through a gasket 39. The vibratory member 13 is provided, at a center thereof, with an opening to which a cap 38 is attached to prevent an invasion of foreign substances into the voice coil 31a.

According to the electro-acoustic converter 100 of FIG. 8, the weight of the vibratory plate 15 is reduced in comparison with the conventional wooden vibratory plate due to the surface layer 2 having a thickness less than 140 μm in the vibratory plate 15. Thus, it is possible to improve the output sound pressure level (frequency characteristic) in a low-frequency range, whereby the electro-acoustic converter 100 can be provided with enhanced acoustic characteristics.

FIG. 9 is a sectional view showing one example of a second electro-acoustic converter 200 equipped with a vibratory plate 16 of the embodiment of the present invention.

As shown in FIG. 9, the second electro-acoustic converter 200 includes a frame 45 accommodating a magnetic circuit 44 and the vibratory plate 16 fixed to an outer edge of the frame 45. The magnetic circuit 44 contains a magnetic pole 41, a center pole 42 and a permanent magnet 43. The magnetic pole 41, the center pole 42 and the permanent magnet 43 are engaged with a columnar projection 19 projecting from a recess of the frame 45 and accommodated in the frame 45 through a given gap G between the magnetic pole 41 and the center pole 42.

The molded bodies 1a to 1c of this embodiment may be used as the vibratory plate 16 of FIG. 9.

The vibratory plate 16 includes a center vibratory part having a generally-domical shaped cross section, a circumferential vibratory part arranged over the whole circumference of the center vibratory part and an edge 17 arranged over the whole circumference of the circumferential vibratory part. The edge 17 is fixed to an outer edge of the frame 6. A voice coil 18 is connected to a joint part between the center vibratory part and the circumferential vibratory part of the vibratory plate 16 by adhesive agent or the like. The voice coil 18 is suspended in the gap G arranged between the magnetic pole 41 and the center pole 42.

Similarly to the electro-acoustic converter 100 of FIG. 8, the second electro-acoustic converter 200 of FIG. 9 is also capable of improving the output sound pressure level (frequency characteristic) in a low-frequency range, allowing the acoustic characteristics to be enhanced furthermore.

—Lighting Equipment—

FIG. 10 illustrates an example where the molded body of the embodiment is applied to a lighting equipment 8. In this embodiment, the molded bodies (wooden sheets) 1a to 1c shown in FIGS. 1 to 3 are utilized for lamp shades 82 secured to columns 81 of the lighting equipment 8.

The lighting equipment 8 of the embodiment is easy to transmit light since wooded portions on the surfaces of the lamp shades 82 are extremely thin and in addition, small interfiber gaps are present in the wood parts. Accordingly, the lighting equipment of the embodiment can provide a brightness higher than that of a lighting equipment made from conventional Japanese papers or sliced veneers having thicknesses more than 140 μm. In addition, if forming curved surface shapes like the lamp shades 82 of the lighting equipment 8 with the use of the molded bodies 1a to 1c of the embodiment, curved surface shapes can be easily formed with great curvatures without producing any crack or breakage owing to the cushioning action of a gap in the surface layer 2. This means the invention enables lighting equipments to be manufactured with a variety of designs.

Thus, although the present invention is described with reference to the above-mentioned embodiment, it shouldn't be understood that these descriptions and drawings constituting this disclosure partially are limitative to the present invention. Note that the whole specification of Japanese Patent Application No. 2008-146144 filed on Jun. 3, 2008 is incorporated herein by reference. Of course, the present invention is intended to include various embodiments undescribed herein and therefore, various alternative embodiments, examples and operational techniques will be apparent from this disclosure to skill in art.

### INDUSTRIAL APPLICABILITY

The present invention is applicable to various products using wood materials, for example, vibratory plates, electro-acoustic converters, lighting equipments, architectural materials, casings for home electric appliances, surface woods for furnishings, etc. and also applicable to manufacturing methods thereof.

1-11. (canceled)

12. A vibratory plate comprising:
a first layer containing a fiber material and having a first surface and a second surface opposing the first surface;
a second layer containing a sliced natural wood in the form of a single sheet having a thickness less than 140 μm, the second layer having a third surface arranged on the second surface, a fourth surface opposing the third surface and a gap formed between wood fibers of the natural wood containing a through-hole penetrating from the third surface to the fourth surface; and
a resin part provided in the first layer and the second layer to join the first layer and the second layer adhesively, wherein
the resin part is arranged in the wood fibers and the gap of the second layer so that a fill ration of the resin part on the fourth surface gets smaller than a fill ration of the resin part on the third surface.

13. The vibratory plate of claim 12, wherein the second layer has a thickness of 50 μm to 120 μm.

14. The vibratory plate of claim 12 wherein the resin part is obtained by filling resin in the first layer into the second layer by hot press.

15. The vibratory plate of claim 12 further comprising a third layer arranged on the first surface.

16. The vibratory plate of claim 12, further comprising a fourth layer containing a sliced natural wood in the form of a single sheet having a thickness less than 140 μm, the fourth layer having a fifth surface arranged on the first surface of the first layer, a sixth surface opposing the fifth surface and a gap formed between wood fibers of the natural wood containing a through-hole penetrating from the fifth surface to the sixth surface, wherein
the resin part further joins the first layer and the fourth layer adhesively and is further arranged in the wood fibers and the gap of the fourth layer so that a fill ration of the resin part on the sixth surface gets smaller than a fill ration of the resin part on the fifth surface.

17. An electro-acoustic converter using the vibratory plate of claim 12.

18. A method of manufacturing a vibratory plate, comprising the steps of:
impregnating a first layer with resin, the first layer containing a fiber material and having a first surface and a second surface opposing the first surface;
drying the first layer impregnated in the preceding step;
preparing a second layer containing a sliced natural wood in the form of a single sheet having a thickness less than 140 μm, the second layer having a third surface, a fourth surface opposing the third surface and a gap formed between wood fibers of the natural wood containing a through-hole penetrating from the third surface to the fourth surface, and further arranging the third surface of the second layer on the second surface of the first layer;
supplying the first layer and the second layer with water thereby to soften them;
adhesively joining the first layer and the second layer through the resin by hot-pressing the first layer and the second layer softened in the preceding step so that the second layer is filled with the resin in the first layer; and
molding the first layer and the second layer adhesively joined in. the preceding step into a vibratory-plate shape, wherein
the adhesively joining step consists in filling the wood fibers and the gap of the second layer with the resin in the first layer so that a fill ration of the resin on the fourth surface of the second layer gets smaller than a fill ration of the resin on the third surface.

19. A method of manufacturing a vibratory plate, comprising the steps of:
impregnating a first layer with resin, the first layer containing a fiber material and having a first surface and a second surface opposing the first surface;
drying the first layer impregnated in the preceding step;
preparing a second layer containing a sliced natural wood in the form of a single sheet having a thickness less than 140 μm, the second layer having a third surface, a fourth surface opposing the third surface and a gap formed between wood fibers of the natural wood containing a through-hole penetrating from the third surface to the fourth surface, and a fourth layer containing a sliced natural wood in the form of a single sheet having a thickness less than 140 μm, the fourth layer having a fifth surface and a sixth surface opposing the fifth surface and a gap formed between wood fibers of the natural wood containing a through-hole penetrating from the fifth surface to the sixth surface, and further arranging the fifth surface of the fourth layer on the first surface of the first layer;
supplying the second layer, the fourth layer, and the first layer with water thereby to soften them;
on condition of overlapping the third surface of the second layer softened in the preceding step and the second surface of the first layer softened in the preceding step on each other and also overlapping the fifth surface of the fourth layer softened in the preceding step and the first surface of the first layer softened in the preceding step on each other,
adhesively joining the first layer, the second layer and the fourth layer through the resin by hot-pressing the first layer, the second layer and the fourth layer softened in the preceding step so that the second layer and the fourth layer are filled with the resin in the first layer; and
molding the first layer, the second layer and the fourth layer adhesively joined in the preceding step into a vibratory-plate shape, wherein
the adhesively joining step consists in:
filling the wood fibers and the gap of the second layer with the resin in the first layer so that a fill ration of the resin on the fourth surface of the second layer gets smaller than a fill ration of the resin on the third surface; and
filling the wood fibers and the gap of the fourth layer with the resin in the first layer so that a fill ration of the resin on the sixth surface of the fourth layer gets smaller than a fill ration of the resin on the fifth surface.

20. The method of manufacturing the vibratory plate of claim 18, wherein the adhesively joining step includes a step of hot-pressing at a temperature of 160° C. to 220° C. and under a pressure of 0.2 MPa to 1.5 Mpa.

21. A molded body comprising:
a first layer containing a fiber material and having a first surface and a second surface opposing the first surface;
a second layer containing a sliced natural wood in the form of a single sheet having a thickness less than 140 μm, the second layer having a third surface arranged on the second surface, a fourth surface opposing the third surface and a gap formed between wood fibers of the natural wood containing a through-hole penetrating from the third surface to the fourth surface; and
a resin part provided in the first layer and the second layer to join the first layer and the second layer adhesively, wherein
the resin part is arranged in the wood fibers and the gap of the second layer so that a fill ration of the resin part on the fourth surface gets smaller than a fill ration of the resin part on the third surface.

22. The molded body of claim 21, further comprising a fourth layer containing a sliced natural wood in the form of a single sheet having a thickness less than 140 μm, the fourth layer having a fifth surface arranged on the first surface of the first layer, a sixth surface opposing the fifth surface and a gap formed between wood fibers of the natural wood containing a through-hole penetrating from the fifth surface to the sixth surface, wherein
the resin part further joins the first layer and the fourth layer adhesively and is further arranged in the wood fibers and the gap of the fourth layer so that a fill ration of the resin part on the sixth surface gets smaller than a fill ration of the resin part on the fifth surface.

23. The method of manufacturing the vibratory plate of claim 19, wherein the adhesively joining step includes a step of hot-pressing at a temperature of 160° C. to 220° C. and under a pressure of 0.2 MPa to 1.5 Mpa.
